(19) United States
(12) Patent Application Publication
(10) Pub. No.: US 2010/0036801 A1
(43) Pub. Date: Feb. 11, 2010

(54) STRUCTURED QUERY LANGUAGE FUNCTION IN-LINING

(76) Inventors: Behzad Pirvali, Van Nuys, CA (US); Fabrizio Blanco, Los Angeles, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/188,915

(22) Filed: Aug. 8, 2008

(51) Int. Cl. G06F 17/30

(52) U.S. Cl. 707/2; 707/E17.017

(57) ABSTRACT

Methods and apparatus, including computer program products, related to query language function in-lining. In general, data characterizing a query in accordance with structured query language format is received. A determination is made as to whether the query includes qualified function calls. If the query includes the qualified function calls, operations are performed that include: mapping available values from the qualified function calls to available parameters of the qualified functions referred to by the qualified function calls; replacing the qualified function calls with data derived from a body of code to be executed when a corresponding function is called, where the replacing is to generate a modified query and the data derived from the body of code is based on the mapping; and providing the modified query to be executed as a substitute for an original version of the query.

### BACKGROUND

The present disclosure relates to data processing and, more particularly, to query language function in-lining.

In general, queries of a database of records may be performed using a query language, such as Structured Query Language (SQL). The query language may support functions, including user-defined functions, of which one type may be a scalar user-defined function that may return a scalar data type as a result of a function call. Unlike the built-in functions provided by a relational database management system (RDBMS), user-defined functions are defined by the user. For example, a user may define a function named “Add” with a function signature (e.g., a combination of a name of a function and its inputs, if any) and a body, where the function definition may appear as:

```
Create function Add (X int, Y int)
Returns int
Begin
Return
    Case
    When X is null
        Then Y
    When Y is null
        Then X
    Else
        X+Y
End;
End
```

Following that example, the function Add(X, Y) may be called any number of times throughout a query statement by including a function call in the format of Add(X, Y) in the query statement, where X and Y are any integer (e.g., Add(1, 1) may be a function call within a query statement).

### SUMMARY

The subject matter disclosed herein provides methods and apparatus, including computer program products, that implement techniques related to query language function in-lining.

In one aspect, data characterizing a query in accordance with structured query language format is received. A determination is made as to whether the query includes qualified function calls (e.g., functions with no variable declarations in their body). If the query includes the qualified function calls, operations are performed that include: mapping available values from the function calls to available parameters of the functions referred to by the function calls; replacing the function calls with data derived from a body of code to be executed when the corresponding function is called, where the replacing is to generate a modified query to be executed as a substitute for the original version of the query.

The subject matter may be implemented as, for example, computer program products (e.g., as source code or compiled code tangibly embodied in computer-readable storage media), computer-implemented methods, and systems.

Variations may include one or more of the following features.

A structured query language may be in accordance with the American National Standards Institute (ANSI) Structured Query Language 92 standard.

A database optimization engine may perform operations of replacing function calls with versions of bodies of functions.

Replacing function calls may only replace scalar user-defined functions absent of variable declarations in their bodies.

Metadata for functions corresponding to function calls may be retrieved. The metadata may assist in determining which functions are qualified for function in-lining.

Replacing of function calls may include copying a body of code of a function to replace a function call. Replacing function calls may include evaluating statements of a body of code of a function to generate data derived from the body of code for use in a replacement.

The subject matter described herein can be implemented to realize one or more of the following performance advantages. Completely in-lined SQL queries will perform as set operations as opposed to cursor operations because of the scalar function calls. The second advantage stems from the fact that the optimizer is faced with a much simpler query and thus has a much higher chance of generating a so-called “optimal access plan.” Another advantage is the performance gain achieved by removing the overhead of function calls.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIGS. 1A-1B are diagrams of query access plans.

FIGS. 2A-2F are a diagram of a query access plan.

FIGS. 3A-3B are a diagram of a query access plan.

FIG. 4 is a flowchart illustrating a process to perform query language function in-lining.

FIGS. 5A-5B are diagrams of systems to perform query language function in-lining.

### DETAILED DESCRIPTION

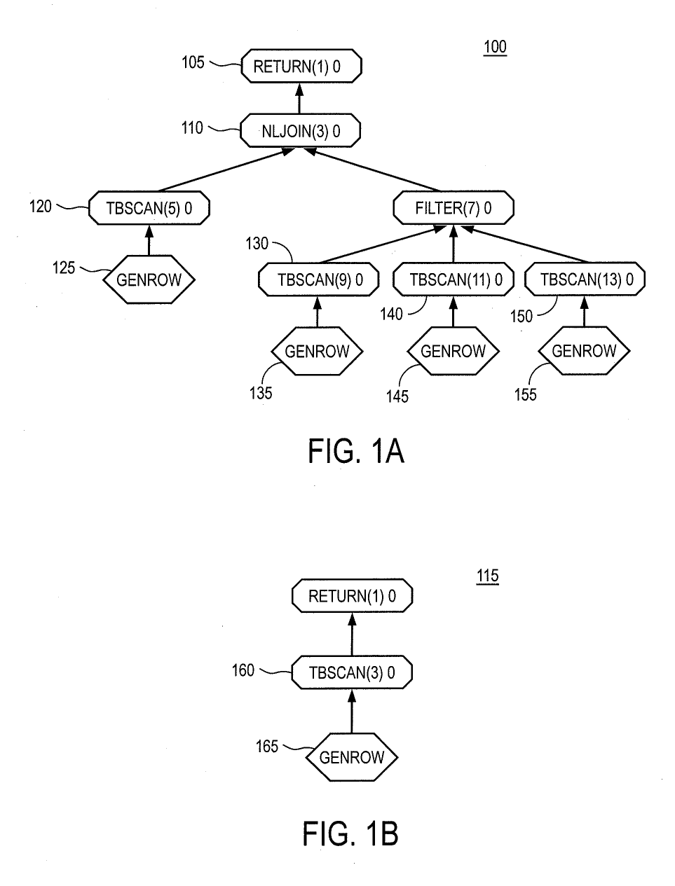

In general, the descriptions of FIGS. 1-5 are related to query language function in-lining. As described with reference to FIGS. 1-5, query language function in-lining relates to replacing one or more function calls in a query statement with data derived from one or more bodies of code of functions. In-lining includes mapping available values of function calls to available parameters of functions (e.g., if there are no available parameters, mapping is not performed). Query statements may be in accordance with a version of Structured Query Language (SQL) (ANSI SQL-92, as an example), of which there may be one or more particular versions of SQL that are supported for function in-lining and the functions may be in accordance with a supported format. Examples of versions of procedural SQL languages for which in-lining may be supported include SQL PL for IBM/DB2, PL/SQL for Oracle. The functions that are in-lined may be limited to a certain type or types. For example, for a query in accordance with SQL language, the functions that are in-lined may be limited to scalar user-defined functions, which may be a type of function that takes zero or more values as input, and provides a scalar data type or null as output. Scalar data types may include those data types that hold a single value and do not have any internal components (e.g., in contrast to composite data types), and scalar data types may be classified into four categories, including character, number, date-time, and Boolean. Examples of base scalar data types for a version of SQL may include char, varchar2, decimal, and integer.

As an example of function in-lining, the above example function “Add” may be in-lined in the following query statement:

SELECT Add(100, 2) Customer FROM sysibm.sysdummy1.

Following that example, the function call Add(100, 2) may be determined to be qualified for replacing with an in-lined statement. This determination of qualification may be based on the function being a scalar user-defined function that has no variable declarations in its body (e.g., an integer Z is not declared within the body of the function definition). A status of qualification may be stored as metadata (e.g., in a table of user-defined functions a qualification flag may exist that may be a zero or one to indicate whether or not a function qualifies for in-lining) for user-defined functions (and, e.g., retrieved to determine whether a function qualifies). Function in-lining involves mapping of available values of the function call to available parameters of the function definition, which, in this example, may involve mapping the value 100 to the parameter X and mapping the value 2 to the parameter Y. The in-lining further involves replacing, in the select query statement, the function call with data derived from the function definition. Different degrees of pre-processing may be performed for the data that replaces the function call.

For example, pre-processing may include replacing variables within a function body with values based on the mapping of parameters such that the select query statement may become:

```
SELECT (
    Case
        When 100 is null
            Then 2
        When 2 is null
            Then 100
        Else
            100+2
        End) Customer FROM sysibm.sysdummy1.
```

As another example, pre-processing may include evaluating portions of the body of the function such that the select query statement may become:

SELECT (100+2) Customer FROM sysibm.sysdummy1.

As another example, pre-processing may include evaluating as much the body of the function as possible such that the select query statement may become:

SELECT (102) Customer FROM sysibm.sysdummy1.

As another example of function in-lining, a function named fn_ex_convert may include the following signature and body:

```
create function fn_ex_convert (p_value double, exa_rate double,
exp_rate double)
returns double
begin atomic
return
case
    when exa_rate = exp_rate
        then p_value
    when exa_rate is null or exp_rate is null or exa_rate=0
        then 0.0
    else
        p_value * exp_rate/exa_rate
    end;
    end.
```

An example function call may be fn_ex_convert(100,2,1), which may be in a select query statement, such as:

SELECT fn_ex_convert(100, 2, 1) converted_amount FROM sysibm.sysdummy1.

A select query statement with an in-line version of that function may be written as:

```
SELECT
(case
    when 2 = 1
        then 100
    when 2 is null or 1 is null or 2=0
        then 0.0
    else
        100 * 1 / 2
end)
converted_amount FROM sysibm.sysdummy1.
```

In the example select query statement, the function call fn_ex_convert(100, 2, 1) is replaced, as part of the SQL in-lining, with a version of the body of the code of the function. The version of the code that replaces the function call may be described as starting with the case statement surrounded by parentheses; the function body may be described as starting with the “returns” clause and ending with the “end” clause; and the values of the function call, 100, 2, and 1, may be described as being mapped to the parameters p_value, exa_rate, and exp_rate such that instances of the variables p_value, exa_rate, and exp_rate in the function body are replaced with the values of the function call, 100, 2, and 1, respectively.

Functions that are in-lined may be limited to scalar user-defined functions. In addition or alternatively, only those functions that have no declarations of variables in their body may be used to perform function in-lining.

Function in-lining may improve SQL query performance in one or more of three ways, including: by converting “cursor operations” to “set operations,” which may be much faster; potentially reducing overall complexity of a query, which may lead to significantly more efficient “query access plans” (e.g., generated by a query optimizer); and eliminating overhead of function calls (e.g., for each row).

As per converting “cursor operations” to “set operations,” which are, in general, much faster, SQL language is designed to perform large set operations. When using user-defined functions, and, in particular, scalar user-defined functions, an SQL database engine might fall back to use cursor operations and go through a set, one row at the time, instead of performing a potentially more optimized set operation.

As per potentially reducing an overall complexity of a query, which may lead to significantly more efficient “query access plans,” such results may be found using cost-based optimizers. Database cost-based optimizers (CBOs) may be very complex software simulators that try to weigh the expected performance of various alternative data access paths to solve an SQL task (e.g., performing a query). To perform such a simulation, a CBO may consider the overall computation power by taking into account available central processing units (CPU; e.g., a number of CPUs and their characteristics), random access memory (RAM; e.g., an amount of memory and other characteristics), input/output bandwidth, network latency/bandwidth, and data distribution based on available data statistics (e.g., an average number of blocks for a value in a particular table or index). For a simulation, an increasing number of joins and complex sorting requirements may increase the number of alternative data access paths exponentially.

For a typical data warehouse with complex queries (e.g., having a number of joins, complex sorting criteria, or both), a CBO might evaluate thousands of different data access paths in order to find one with a lowest cost. In general, CBOs may miss a true ideal data access path (e.g., a data access path with the best performance when executed by a database engine) and generate an inefficient data access plan (where a data access plan is a combination of data access paths for a query) due to not being able to go through all the alternative paths with the available computation power and resources in the required time. Thus, reducing complexity tends to reduce the number of alternative access paths. At the same time, it also makes the remaining alternative access paths much simpler thereby reducing the required computational power and time for the simulation. This, in turn, results in CBO having much higher chance to find an efficient access plan.

FIGS. 1-3 include diagrams of query access plans. A query access plan may be a graphical representation of SQL tasks to be performed for a query. Tasks in the query plan may be represented by nodes that are polygons, where different shapes of polygons may represent different types of data or operations for which tasks are performed; e.g., tables may be shown as rectangles, indexes may be shown as diamonds, operators (e.g., such as a join) may be shown as octagons, TQUEUE (a table queue that is used to pass table data from one database agent to another) and operators may be shown as parallelograms. A name of a task may be represented in the polygon and may be followed by a number that is an indication of a resource cost (in timerons, which may be its own unit of measurement and may have no direct relationship to a cost as a measure of time, such as seconds) to perform tasks up to the point of a node from all of its child branches (i.e., a cumulative cost of a node and its child nodes, if any, may be indicated in each node). Arrows that connect nodes in a query access plan may show a direction of data flow (e.g., from a child node to a parent node). For example, in the query access plan 100 of FIG. 1A, the arrow between the RETURN node 105 and the NLJOIN node 110 may indicate that data from the NLJOIN node 110 flows to the RETURN node 105. In addition, the zero after each description in the octagonal nodes may indicate that all tasks are of such low cost as to be rounded to zero timerons.

Returning to the discussion of reducing query complexity, in-lining may be a great way to significantly reduce query complexity. Following the earlier example query statement of “SELECT fn_ex_convert(100, 2, 1) converted_amount FROM sysibm.sysdummy1,” that query statement may have the query access plan 100 of FIG. 1A in a DB2 system, where the query access plan may be generated by a CBO engine. After performing the in-lining on this SELECT statement, we may get the query access plan 115 of FIG. 1B in a DB2 system, where the query access plan may be generated by an CBO engine.

While the query access plan 100 of FIG. 1A has four generated temporary tables (generated by the table functions GENROW (generate a table of rows) 125, 135, 145, 155), which have to be read (read by the operators TBSCAN (table scan) 120, 130, 140, 150), there is only one generated temporary table (generated by the table function GENROW 160) for the query access plan 115 of FIG. 1B that has to be read (read by the operator TBSCAN 165). Thus, the same overall functionality may require many fewer tasks when a function is in-lined. This simplification resulting from function in-lining may make a query much easier for an optimization engine to digest and increases the chance of an optimization engine calculating a more efficient access plan. In a production system, the in-lined version of heavy queries were shown to be running around ten to twenty times faster because a CBO was able to calculate a much better access plan.

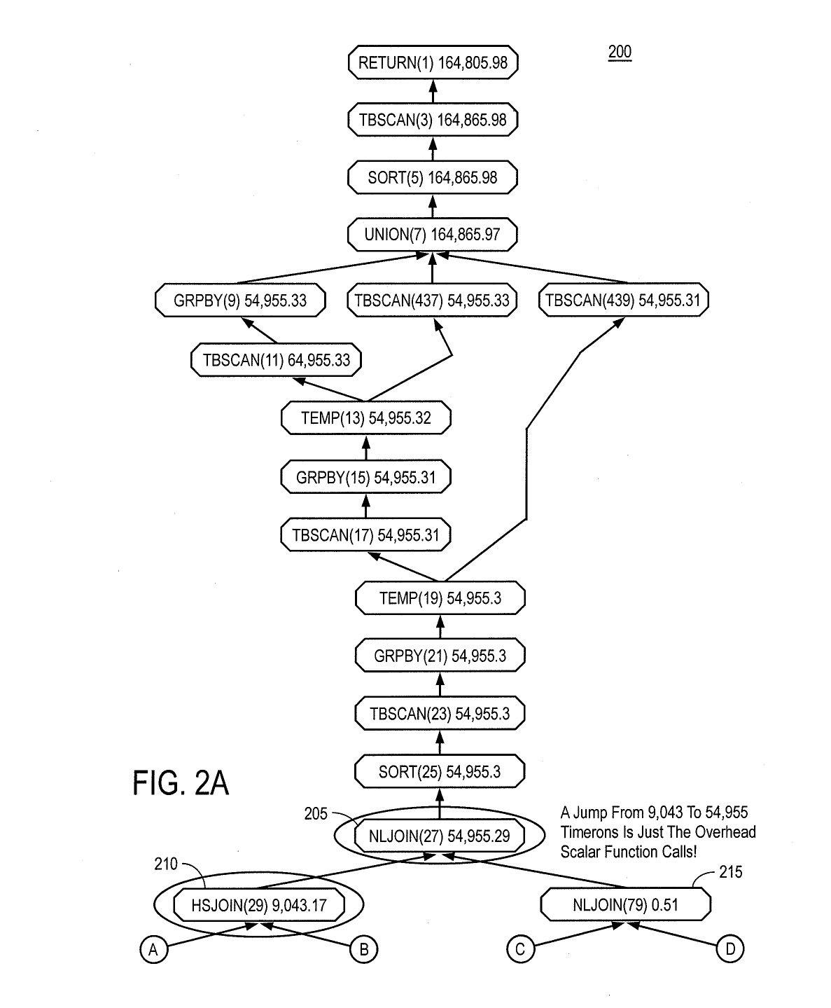

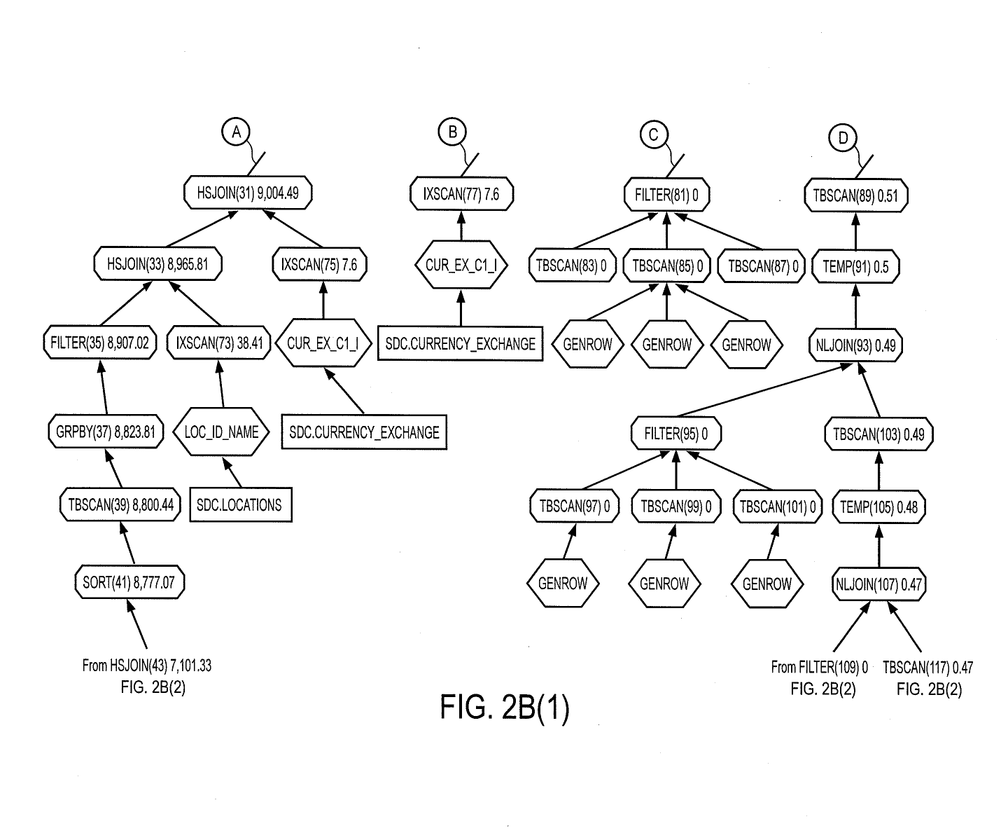

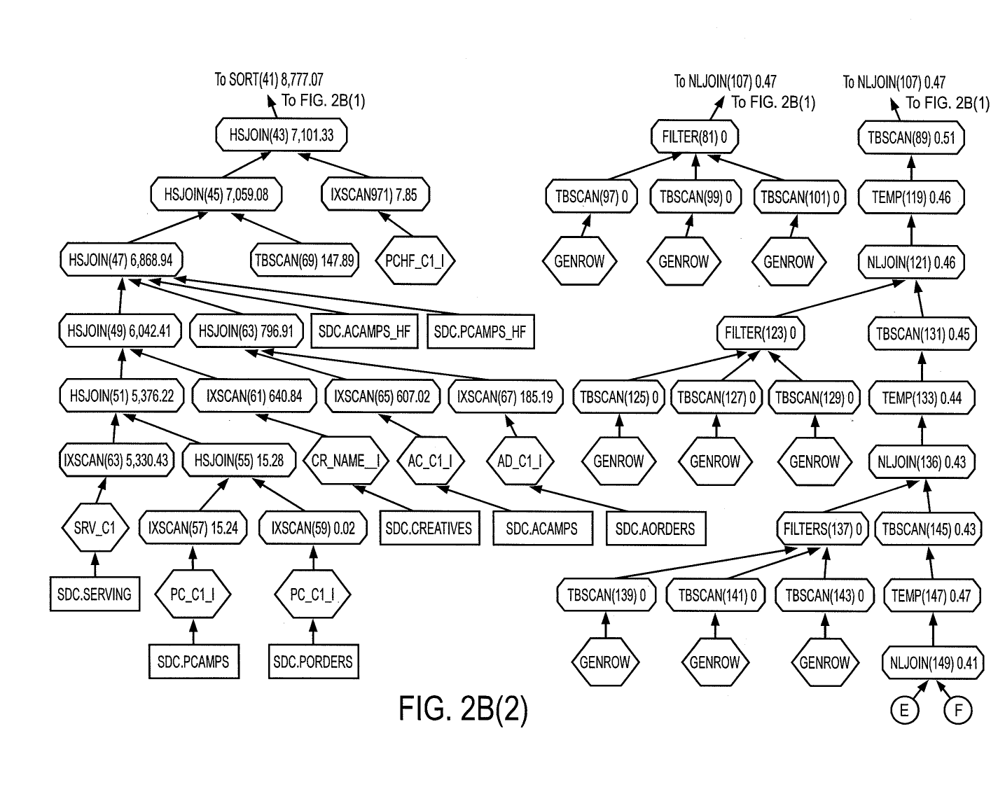

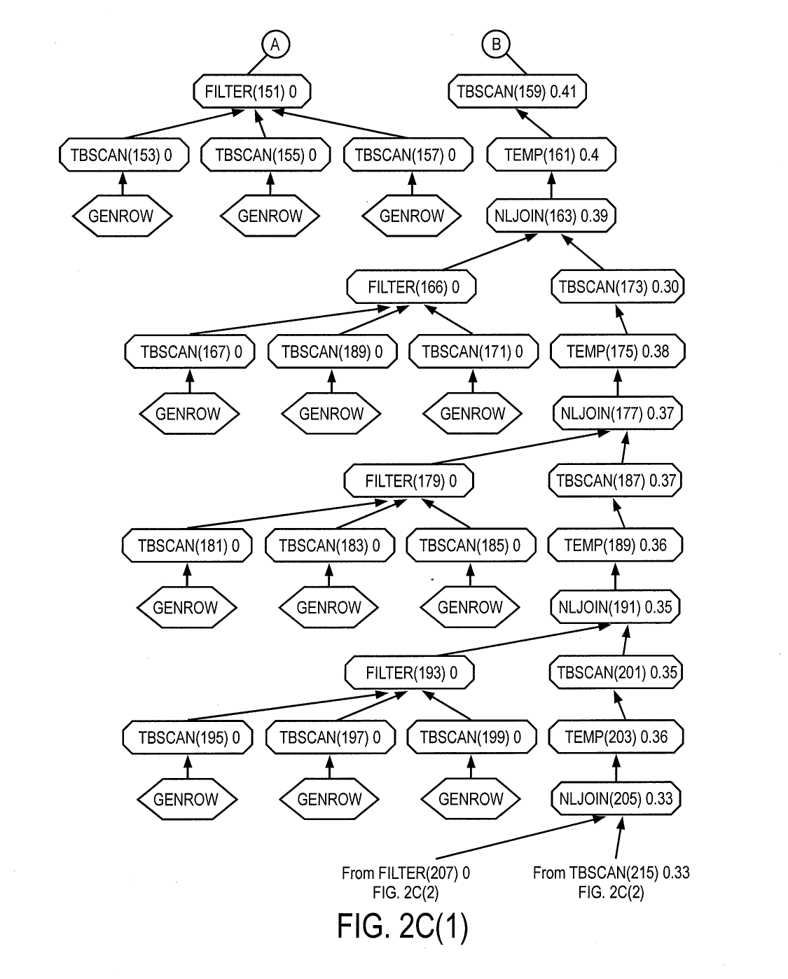

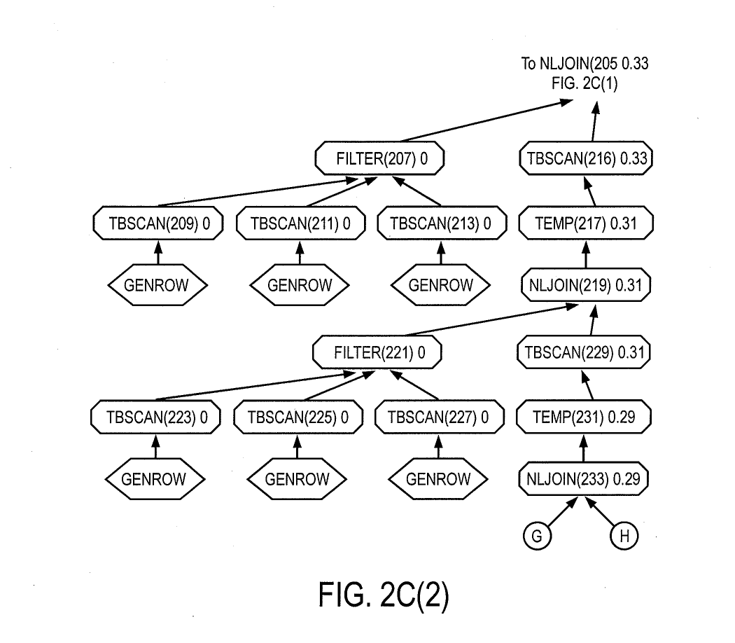

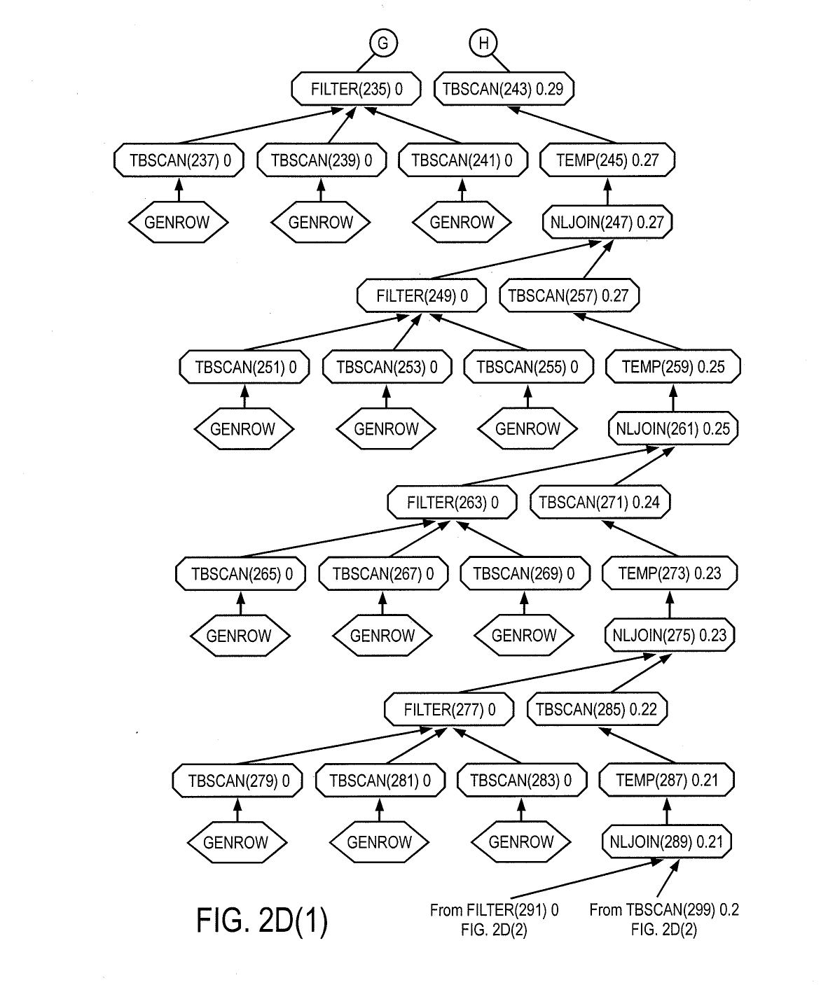

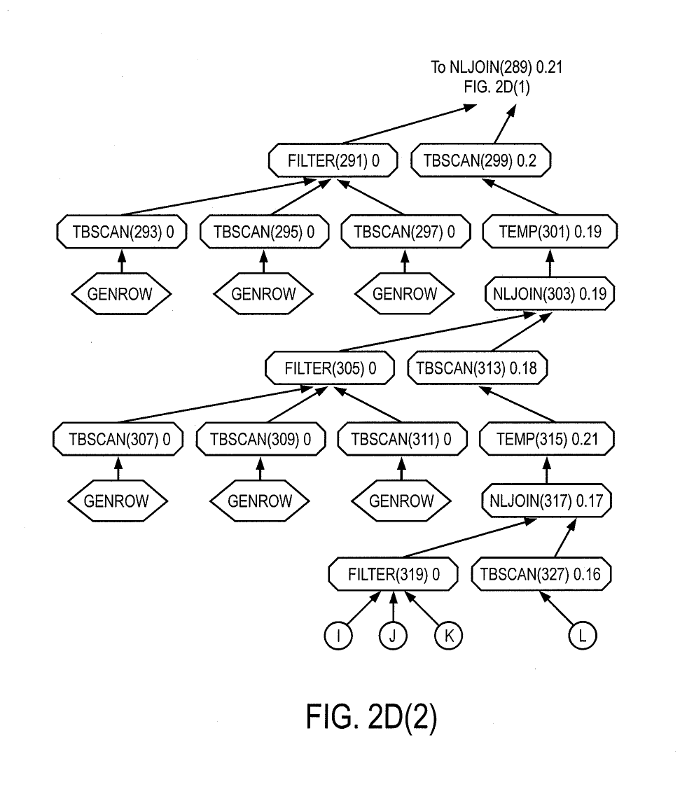

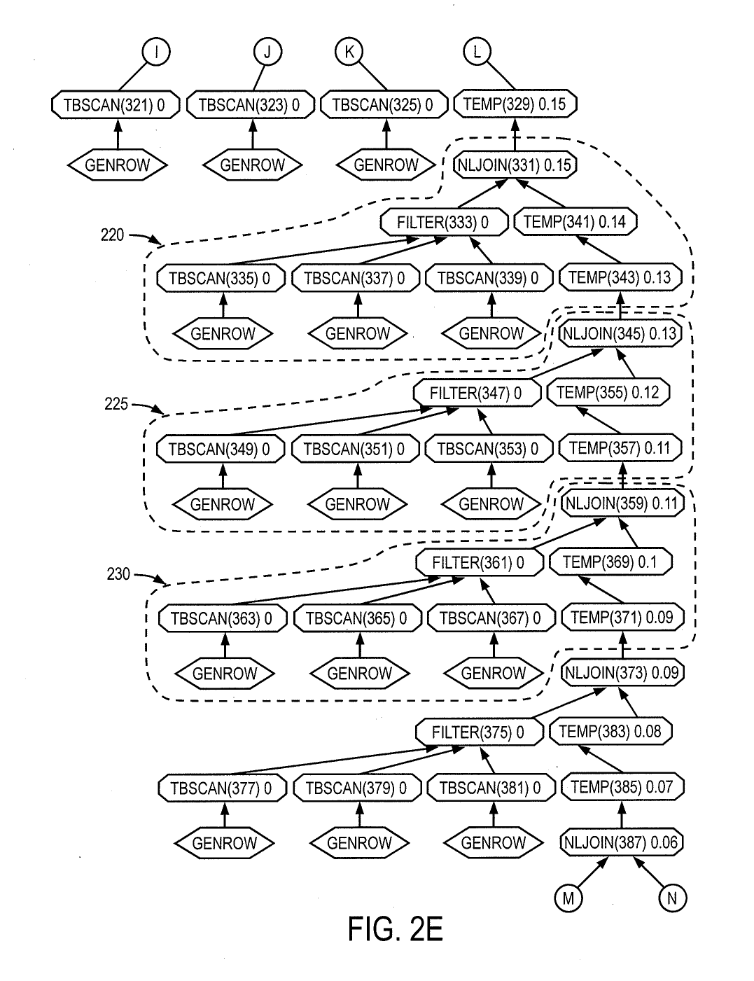

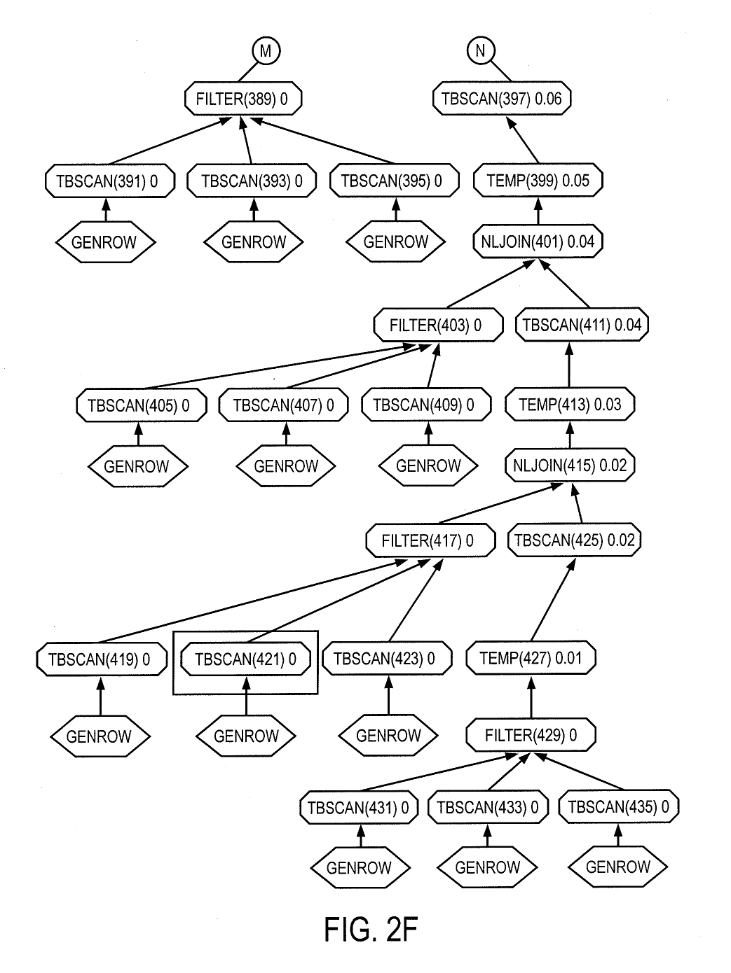

FIGS. 2A-2F are a diagram of a query access plan. The query access plan of FIGS. 2A-2F may be a result of an example query report containing numerous scalar function calls before performing the function in-lining (e.g., a DB2 CBO example), where the report is included below in the section of the detailed description entitled “Example Report Before Performing Function In-lining.” That report is written in SQL language. As indicated in the portion of the access plan shown in FIG. 2A, the cost of the access plan jumps from 9,043 timerons to almost 55,000 timerons mostly due to the processing of scalar function calls on the right-side of the first section 200 of the access plan. In particular, the operator node HSJOIN (Hash Join) 210 has a cumulative cost of 9,043 timerons, whereas the operator node NLJOIN (nested loop join) 205 has a cumulative cost of 54,955 timerons, which is a result of combining the left-side tree starting with the operator node HSJOIN 210 and the right-side tree starting with the operator node NLJOIN 215. Thus, a difference between the parent operator node NLJOIN 205 and the child operator node HSJOIN 210 may show an increase caused by nested loop joining with the tree on the right-side starting with the operator node NLJOIN 215, where the operations on the right-side may be a result of an optimization engine generating query access paths for scalar user-defined function calls. The significant increase may be a result of 25 NLJOINs created just for the scalar user-defined function calls. The nested loop joins may be generated as a result of an optimization engine having a pattern of generating, for function calls, a combination of temporary tables that are joined back with a nested loop join. Such a pattern may be seen, for example, in FIG. 2E, by the combination of nodes in groupings 220, 225, 230. Similar patterns may be seen in FIGS. 2B-D and in FIG. 2F.

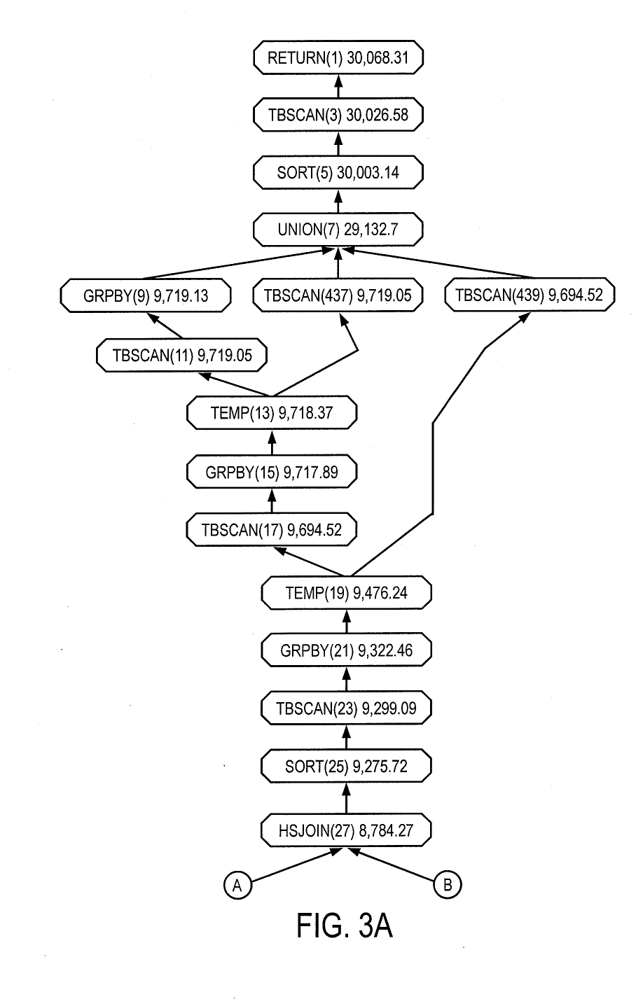

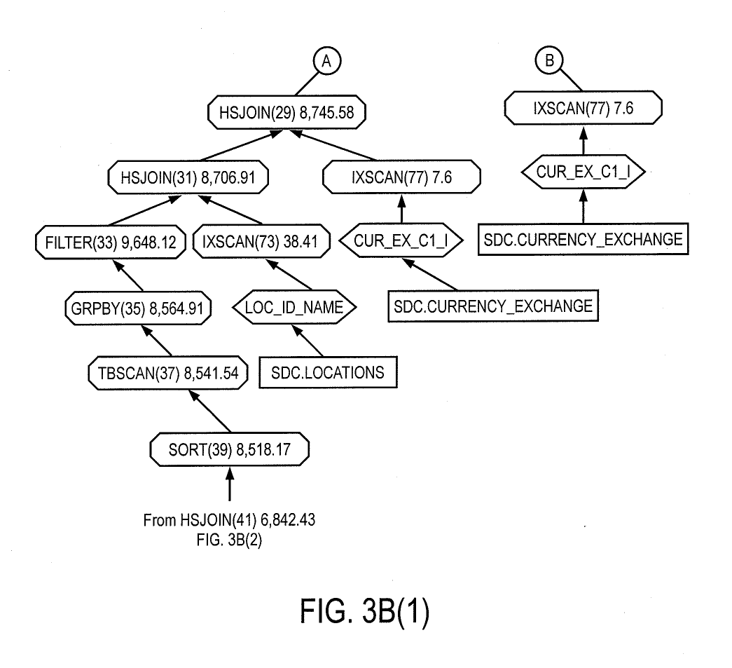

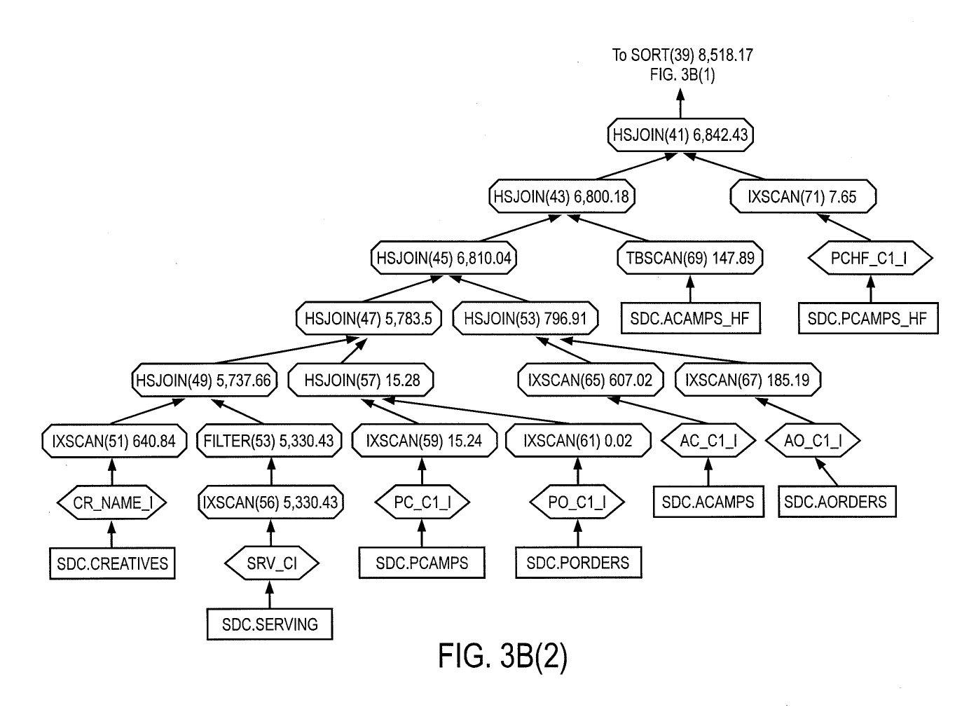

FIGS. 3A-3B are a diagram of a query access plan. The query access plan of FIGS. 3A-3B is the result of the same report after performing function in-lining (e.g., a DB2 CBO example result), where the report is included below in the section of the detailed description entitled “Example Report After Performing Function In-Lining.” In particular, a function named fn_ex_convert (which is the same as the function of the same name described above) is in-lined through a combination of substituting function calls with the body of the function and mapping values to available parameters that are variables throughout the body of instances of the function.

As may be noted by a comparison of the versions of the reports below, the version with some function in-lining in the report is much longer than the version without function in-lining. For example, below shows a snippet of the first version of the report, where the function “fn_ex_convert” is called three times:

THEN sum(fn_ex_convert(adj_revenue, ac_rate, 1) −
fn_ex_convert(cost, pc_rate, 1))/sum(fn_ex_convert(cost, pc_rate, 1))

and that combination of function calls is represented as the following in the second version of the report:

```
THEN sum ( (CASE
      WHEN (ac_rate) = (1)
      THEN (adj_revenue)
      WHEN (ac_rate) is null or (1) is null or (ac_rate) = 0
      THEN 0.0
      ELSE (adj_revenue) * (1)/(ac_rate)
    END) − (CASE
      WHEN (pc_rate) = (1)
      THEN (cost)
      WHEN (pc_rate) is null or (1) is null or (pc_rate) = 0
      THEN 0.0
      ELSE (cost) * (1)/(pc_rate)
    END)) / sum ((CASE
      WHEN (pc_rate) = (1)
      THEN (cost)
      WHEN (pc_rate) is null or (1) is null or (pc_rate) = 0
      THEN 0.0
      ELSE (cost) * (1)/(pc_rate)
    END)).
```

While the size of a version of the report that had function in-lining performed may be much larger, a corresponding, respective access plan as shown in FIGS. 3A-3B is much shorter than a corresponding, respective access plan as shown in FIGS. 2A-2F. In addition, a total estimated cost as shown in the access plans went down from about 160,000 timerons, for the initial report, to about 30,000 timerons for the version of the report on which some function in-lining had been performed. Thus, it may be estimated that the query will be five to six times faster when function in-lining is performed. In a real world test, the version of the query with in-lining ran about sixteen times faster than the initial version of the query that had no in-lining, although results may vary. Thus, performance benefits from in-lining functions in the query are significant. As another example, a query that was tested to return after approximately three hours is able to return results in less than nine minutes with function in-lining applied.

Returning to ways in which performance may be improved by function in-lining, performance may be improved by eliminating an overhead of scalar function calls. For example, in simple queries, where an optimization engine is able to generate a relatively efficient access plan, in-lining was still seen to boost performance by three to seven times. This is considered to be due to possible conversion back to set operations and eliminating function call overhead. Even if this conversion is not possible, just the fact that a function need not have to be called for every single row would improve the performance. The more the number of rows and the more functions are in-lined, the more noticeable is this performance increase.

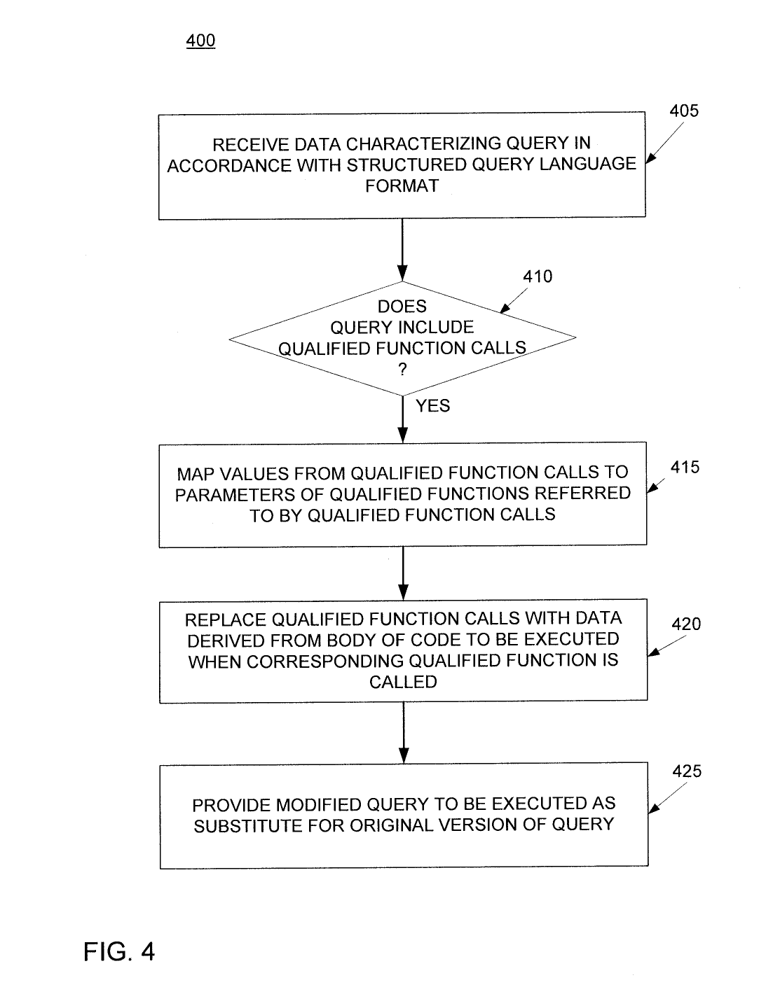

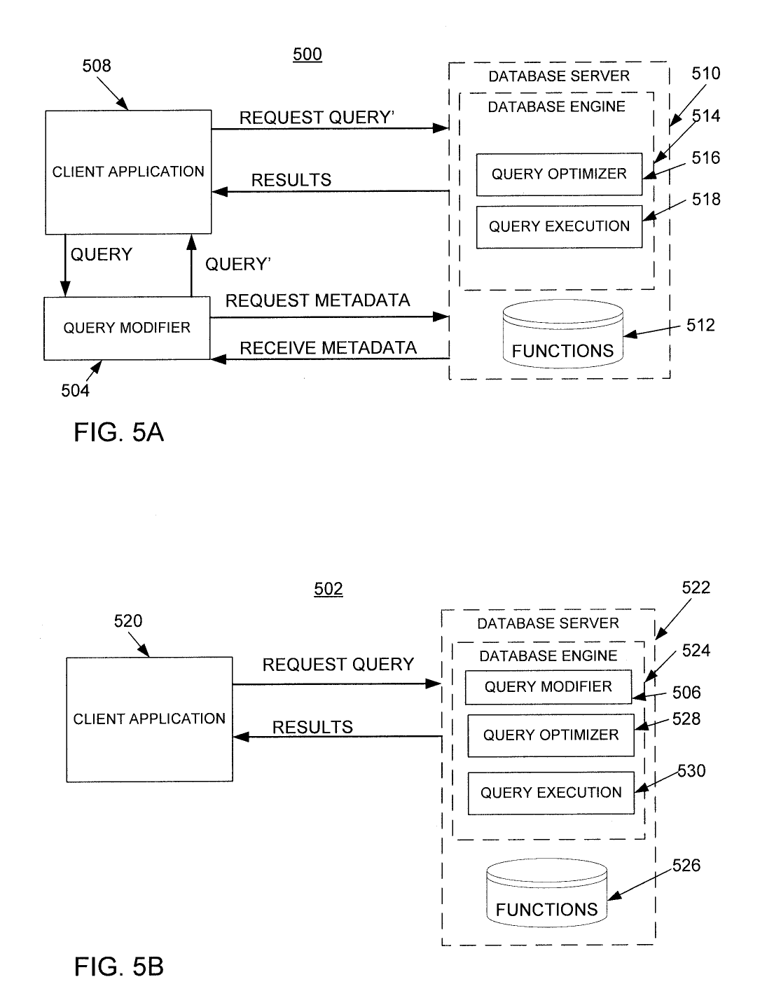

FIG. 4 is a flowchart illustrating a process 400 to perform query language function in-lining. The process 400 may be performed in the systems of FIGS. 5A-5B. In general, the process 400 involves receiving data characterizing a query in accordance with SQL language, where the query includes function calls (405); determining whether the query includes qualified function calls (410); and, if the query includes qualified function calls, mapping available values from function calls to available parameters of functions referred to by the function calls (415), replacing qualified function calls with data derived from a body of code to be executed when a corresponding function is called (420), and providing a modified query to be executed as substitute for an original version of a query (425).

Receiving data characterizing a query in accordance with the SQL language, where the query includes function calls (405), may include receiving a query of an SQL report, receiving a link to a query, and the like. There may also be various function calls, which may be located in various parts of a query. The receiving of the data may include, as examples, receiving the data as part of a request to optimize a query and nothing more, receiving the data as part of a request to perform a query, and the like. The receiving may be performed by a query optimization engine, which may be a part of a database engine, or another component. In some scenarios a query might not include function calls, or function calls in a query might be determined to not be in-lined, in which case the mapping, the replacing, or both might not be performed.

Determining whether a query includes qualified function calls (410) may include, as an example, parsing a query characterized by data that is received (405) to find qualified function calls in a format of [name], [zero or more parameters]. In some scenarios no function calls may be found at which point a process may differ (e.g., the process might terminate) or it may just return the query received without changing it. The determining may be performed by a query optimization engine, which may be a part of a database engine; by a parser that is a separate tool that is specialized to perform parsing; or by another component. A function call may be considered qualified if it is a call to a function that is qualified, where a function may be qualified if it meets certain conditions that may indicate a function may be in-lined. For example, qualified functions may be user-defined scalar functions and qualified function calls may be function calls to those types of functions.

If the query includes qualified function call, the process 400 may continue by mapping available values from function calls to available parameters of functions referred to by the qualified functions (415); otherwise, in implementations, the process 400 may end or return the initial query without changing it.

Mapping available values from function calls to available parameters of functions referred to by qualified function calls (415) may include, as an example, reading the values of a function call, finding parameters in a function signature referenced by the function call, and generating a mapping based on a corresponding order of values and parameters. For example, for the example function Add and the example select query statement including Add described above, the values 100 and 2 may be read from a function call, the parameters X and Y may be read from a function definition, a mapping between the value 100 and the parameter X may be generated (which may be based on the order of values and order of parameters; i.e., 100 being a first value in the function call and X being a first parameter in the function signature), and a mapping between the value 2 and the parameter Y may be generated based on the order of values and order of parameters (2 being a second value in the function call and Y being a second parameter in the function signature). In addition to the mapping, variables corresponding to the parameters in a copy of the function body may be replaced with the values that correspond to the variables. For example, for the example function Add and the example select query statement including Add described above, the values 100 and 2 may be read from a function call, the parameters X and Y may be read from a function definition, every instance of the variable X in the function body may be replaced with the value 100, and every instance of the variable Y in the function body may be replaced with the value 2. The mapping may be performed by a query optimization engine or another component. While the mapping is described as being from values to parameters, the mapping need not be performed in a specific order and mappings need not be stored in a specific order.

Replacing one or more function calls with data derived from a body of code to be executed when a corresponding function is called (420) may include, for example, editing a query to include a body of a function, with variables of parameters replaced with values, in place of a corresponding function call. Functions may be pre-processed (e.g., before, after, or both a mapping is performed) such that data derived from a body of code may have significant differences from the body of the function in a function definition. For example, a function may be pre-processed to an extent that a value resulting from an evaluation of all statements in a function may replace a function call. The data may include one or more instructions or statements, and may be, as an example, any data replacing the function call. The replacing may be performed by an optimization engine or another component. An existing copy of a query that is analyzed may be edited or a new copy of a query may be generated as part of the sub-process of the replacing.

Providing a modified query to be executed as substitute for an original version of a query (425) may include, as an example, providing a modified query with one or more in-lined functions to a database engine for query execution. The providing a modified query may involve sending a modified query to a client application that may cause the query to be executed by a database server. In implementations, if no function calls are qualified for in-lining (e.g., there are no scalar user-defined functions that are absent of function declarations in their bodies), an original version of a query may be returned for execution.

Although the process 400 of FIG. 4 includes a certain number and type of sub-processes, implementations may differ. For example, the process 400 may further include querying a database server for metadata of user-defined functions, and the metadata may be returned and used to perform function in-lining (e.g., as the metadata may be copies of the functions that may be used to generate bodies of functions for function in-lining). As another example, only function calls for scalar user-defined functions may be replaced with data characterizing their corresponding function bodies. As another example, only function calls for functions that have no declared variables within their body may be replaced with data characterizing their corresponding function bodies. As another example, the process may further include determining whether a function call is qualified, a function is qualified, or both.

FIGS. 5A-5B are diagrams of systems 500, 502 to perform query language function in-lining. The first system 500 differs from the second system 502, in part, due to a query modifier 504 not being part of a database engine in contrast to the query modifier 506. This difference is reflected by different operation of the first and second systems 500, 502, as will be described below.

In general, operation of the first system 500 to perform function in-lining may be as follows. Prior to execution of a query, the client application 508 may request function in-lining of a query from the query modifier 504. To do so, the client application 508 sends a query to the query modifier 504. The query modifier 504 requests function metadata from the database server 510. Function metadata may include definitions of functions, including their signatures and bodies. Function metadata may include indications of which functions qualify for function in-lining (e.g., which functions are scalar user-defined functions that do not have variable declarations in their bodies) such that only those functions that qualify may be returned. The function metadata that is retrieved may be all functions, only those functions referred to in a query, or another subset of functions (e.g., all scalar user-defined functions or all scalar user-defined functions in a query that do not have declared variables in their bodies). The function metadata is stored in a database of function data 512 at the database server 510. Storing of function metadata at a database server is an architectural design of user-defined functions in some relational database management systems (e.g., definitions of user-defined functions might not be included in a query or reside at a client, and may only reside at a database server) and retrieval of function metadata may be a supported service of such systems.

The query modifier 504 uses the function metadata to perform function in-lining in a query. Operation of the query modifier 504 may be in accordance with the process 400 of FIG. 4. As a result of performing function in-lining, a modified query named QUERY′, may be returned to the client application 508.

The query modifier may also optimize the in-lining process, so that it may only ask for the function metadata once, process all the available qualified functions by generating corresponding objects that could be used to perform in-lining much more rapidly when compared to using the initial function definition. Each of these objects may map to a function definition and represent a digested version, which shortens the in-lining process for its corresponding function. These objects can be persisted or cached and used instead of the initial function definitions. This will improve the in-lining performance by not having to ask the database engine for the function definitions every time and by not having to process function definitions each time. In other words, the query modifier can optimize the in-lining process by caching a pre-processed version of all the qualified functions calls. The replacing of function parameters with the function call values could be done much faster using these pre-processed digested versions of the function definitions. This optimization improve the in-lining performance by eliminating the call to the database for user defined functions meta-data every time a query has to be in-lined and by shortening the process of replacing the function parameters in the function body with the function call values. The client application 508 requests the modified query to be executed by the database server 510 by sending the modified query to the database server 510. At the database server 510, the database engine 514 attempts to optimize the query using the query optimizer 516, which may perform query optimization techniques other than function in-lining, and then an optimized query may be executed by the query execution component 518.

The database server 510 may be a relational database management system such as a version of IBM's DB2, where no modification need be made to the server 510 to cope with queries that have been modified with function in-lining.

In response to the request to execute the modified query, a set of results is returned to the client application 508 from the database server 510. The client application 508 and the query modifier 504 may be part of a same computer system running on a same platform; however, they need not be. The query modifier 504 may be a separate computer program from the client application 508 that is accessed by a remote function call through an application programming interface. In implementations, the query modifier 504 may be a JAVA stored procedure that resides at the database server 510.

Operation of the second system 502 to perform function in-lining may be as follows. The client application 520 may send a request for query execution to the database server 522. The request is forwarded to the database engine 524, which causes the query modifier 506 to request function metadata from the functions database 526 to perform function in-lining (e.g., in accordance with the process 400 of FIG. 4). A modified query is then sent to the query optimizer 528, which attempts to further optimize the query and may send the optimized query to the query execution component 530 for execution. Results of the query may be sent to the client application 520.

Differences between operation of the first and second systems 500, 502 may include the following. In contrast to having a client application request queries to be modified via function in-lining separate from requesting execution of the query, as is done with operation of the first system 500, a client application may request query execution and function in-lining may be performed automatically on a query. This may be advantageous, as a client application need not be modified to have functions in its queries in-lined. In addition, the streamlining of function in-lining may reduce an amount of coordination among components. Also, as function metadata may be local to a database server, or otherwise easier or quicker to retrieve by a database server, performance of an overall process of query execution may be improved by, for example, reducing an amount of time for a query to be modified with in-lined functions before execution.

Although the systems 500, 502 of FIGS. 5A-5B include a certain number, type, and configuration of components, implementations may vary. For example, the query modifier 506 may be integrated with the query optimizer 528 in the second system 502 (e.g., as an extension of a query re-write layer or another component in a query processing stack). As another example, a query modifier to perform function in-lining may act as a proxy for a database server such that a client need not be aware that function in-lining is performed. This may be advantageous as adaptation of a client application or database engine need not be performed (e.g., the client application need not be re-configured to cause function in-lining prior to sending a query to a database server). In a proxy scenario, a query optimizer to perform function in-lining may be a proxy component to receive requests for queries from client applications, pass queries to the database server after function in-lining has been performed (e.g., the query optimizer may make calls to the database server as if it were a client application requesting queries), and the proxy may then return results to the client application. As another example, functions may be pre-processed when performing function in-lining such that query execution time may be reduced. As another example, pre-processed functions may be cached in data structure of pre-processed functions when performing function in-lining such that a pre-processed function for use in function in-lining need only be pre-processed once and may be used multiple times, which may reduce a computational cost of performing function in-lining, which may consequently improve a speed of function in-lining.

As an example application of SQL function in-lining, the function in-lining may be implemented in a scenario involving advertisement serving technology. In such a scenario, there may be a need to track statistics, such as a number of displays of an advertisement, a number of clicks on an advertisement, and the like. Access to a database management system for such a scenario may be desired for billing (e.g., to generate reports for accounting purposes) and for generating new advertisements (e.g., to obtain statistics and determine which advertisements work best, such as when targeting users of a specific demographic). Such tasks may require a user interface that displays reports generated from large amounts of data, and the generation of reports on large amounts of data may be a bottleneck to providing a fast user interface experience. For example, a user may wish to generate a report quickly to make business decisions that require a short turn-around time and performance of a query on very large sets of data may be important to provide relevant data. In the scenario, user-defined functions may be used for both sets of tasks and may be determined to be a bottleneck in performance due to how functions are handled by relational database management systems (e.g., by accessing data with a high join order and generating many temporary tables or downgrading a set-operation to a cursor-operation). One technique may be to avoid use of functions; however, this may remove flexibility when generating reports, which may result in other detriments (e.g., as function encapsulation may be lost, which may make queries more difficult to interpret by a human when crafting a query and more error-prone). Function in-lining may allow for efficient execution of queries without sacrificing the ability to include user-defined functions in a query.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, i.e., one or more computer programs tangibly embodied in an information carrier, e.g., in a machine-readable storage device, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Media suitable for embodying computer program instructions and data include all forms of volatile (e.g., random access memory) or non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other in a logical sense and typically interact through a communication network. The relationship of client and server arises by virtue of computer programs running on the respective computers and having a client-server relationship to each other.

The subject matter described herein has been described in terms of particular embodiments, but other embodiments can be implemented and are within the scope of the following claims. For example, operations can differ and still achieve desirable results. As another example, the techniques may be applied to query languages other than SQL. In certain implementations, multitasking and parallel processing may be preferable. Other embodiments are within the scope of the following claims.

Example Report Before Performing Function In-Lining:

```
SELECT
sr.date,
    l.location_id,
    l.name,
    sum(impressions) as impressions,
    sum(rawclicks) as rawclicks,
    sum(registrations) as registrations,
    sum(coalesce(fn_ex_convert(adj_revenue, ac_rate, 1),0)) as adj_revenue,
    sum(fn_ex_convert(coalesce(t_revenue,0), ac_rate, 1)) as t_revenue,
    sum(fn_ex_convert(coalesce(goal_revenue,0), ac_rate, 1)) as g_revenue,
    sum(fn_ex_convert(coalesce(bonus_revenue,0), ac_rate, 1)) as b_revenue,
    sum(t_impressions) as t_impressions,
    sum(t_rawclicks) as t_rawclicks,
    sum(t_registrations) as t_registrations,
    sum(fn_ex_convert(cost, pc_rate, 1)) as tcost,
    sum(fn_ex_convert(adj_revenue, ac_rate, 1) − fn_ex_convert(cost, pc_rate, 1)) as
profit,
    CASE
        WHEN sum(impressions) is not null
        THEN 1
        ELSE 0
    END as impressions_adjusted,
    CASE
        WHEN sum(rawclicks) is not null
        THEN 1
        ELSE 0
    END as rawclicks_adjusted,
    CASE
        WHEN sum(registrations) is not null
        THEN 1
        ELSE 0
    END as registrations_adjusted,
    CASE
        WHEN sum(fn_ex_convert(cost, pc_rate, 1)) > 0
        THEN sum(fn_ex_convert(adj_revenue, ac_rate, 1) − fn_ex_convert(cost,
pc_rate, 1))/sum(fn_ex_convert(cost, pc_rate, 1))
        ELSE null
    END as roi,
    CASE
        WHEN sum(impressions) > 0
        THEN 1000.0*sum( fn_ex_convert(adj_revenue, ac_rate, 1)) /
(sum(impressions))
        ELSE −1
    END as rpm,
    CASE
        WHEN sum(impressions) > 0
        THEN 1000.0*sum( fn_ex_convert(cost, pc_rate, 1)) / (sum(impressions))
        ELSE −1
    END as cpm,
    CASE
        WHEN sum(impressions) > 0
        THEN 1000.0*sum( fn_ex_convert(adj_revenue, ac_rate, 1) −
fn_ex_convert(cost, pc_rate, 1)) / (sum(impressions))
        ELSE null
    END as gpm,
    CASE
        WHEN sum(impressions) > 0
        THEN 100.0 * sum(rawclicks)/sum(impressions)
        ELSE −1
    END as ctr,
    CASE
        WHEN sum(rawclicks) > 0
        THEN sum(fn_ex_convert(adj_revenue, ac_rate, 1))/sum(rawclicks)
        ELSE −1
    END as rpc,
    CASE
        WHEN sum(impressions) > 0
        THEN 100.0 * sum(registrations)/sum(impressions)
        ELSE −1
    END as convrate,
    CASE
        WHEN sum(registrations) > 0
        THEN sum(fn_ex_convert(adj_revenue, ac_rate, 1))/sum(registrations)
        ELSE −1
    END  as rpa,
    CASE
        WHEN sum(t_impressions) > 0
        THEN 1000.0 * sum(fn_ex_convert(adj_revenue, ac_rate,
1))/sum(t_impressions)
        ELSE −1
    END as ecpm,
    CASE
        WHEN sum(rawclicks) <> 0
        THEN sum(registrations)/sum(rawclicks)
        ELSE −1
    END as apc,
    CASE
        WHEN sum(rawclicks) <> 0
        THEN sum(fn_ex_convert(adj_revenue, ac_rate, 1) − fn_ex_convert(cost,
pc_rate, 1))/sum(rawclicks)
        ELSE null
    END as gppc,
    CASE
        WHEN sum(registrations) <> 0
        THEN sum(fn_ex_convert(adj_revenue, ac_rate, 1) − fn_ex_convert(cost,
pc_rate, 1))/sum(registrations)
        ELSE null
    END as gppa,
    CASE
        WHEN sum(coalesce(fn_ex_convert(adj_revenue, ac_rate, 1),0)) <> 0
        THEN (sum(coalesce(fn_ex_convert(adj_revenue, ac_rate, 1),0)) −
        sum(fn_ex_convert(cost, pc_rate, 1))) /
sum(coalesce(fn_ex_convert(adj_revenue, ac_rate, 1),0))
        ELSE null
    END as mrgn ,
    ‘-’ as adtype_name ,
    −1 as creatives_n,
    −1 as acamps_n ,
    −1 as publishers_n
    FROM table (fn_revenue_report2(date(‘2007-08-11’), date(‘2007-08-11’), −1, −1, −1, −
1, −1, −1, −1, −1)) sr
    JOIN locations 1 ON sr.node_id = l.location_id
    WHERE
        sr.date BETWEEN ‘2007-08-11’
        and ‘2007-08-11’
        and cr_name != ‘_SDC_NOSERV_’
        and sr.po_test = 0
    GROUP BY
        grouping sets((sr.date, l.location_id, l.name), (l.location_id, l.name),( ))
    ORDER BY
        grouping(name) ,
        location_id,
        name,
        sr.date ,
        impressions DESC
    OPTIMIZE FOR 1000 ROWS
    WITH ur;
```

Example Report After Performing Function In-Lining:

```
SELECT sr.date, l.location_id, l.name, sum(impressions) as impressions, sum(rawclicks) as
    rawclicks, sum(registrations) as registrations, sum(coalesce(
      (CASE
        WHEN (ac_rate) = (1)
        THEN (adj_revenue)
        WHEN (ac_rate) is null or (1) is null or (ac_rate) = 0
        THEN 0.0
        ELSE (adj_revenue) * (1)/(ac_rate)
        END),0)) as adj_revenue,
    sum ((CASE
        WHEN (ac_rate) = (1)
        THEN coalesce(t_revenue,0)
        WHEN (ac_rate) is null or (1) is null or (ac_rate) = 0
        THEN 0.0
        ELSE coalesce(t_revenue,0) * (1)/(ac_rate)
        END)) as t_revenue,
    sum ((CASE
        WHEN (ac_rate) = (1)
        THEN coalesce(goal_revenue,0)
        WHEN (ac_rate) is null or (1) is null or (ac_rate) = 0
        THEN 0.0
        ELSE coalesce(goal_revenue,0) * (1)/(ac_rate)
        END)) as g_revenue,
    sum ((CASE
        WHEN (ac_rate) = (1)
        THEN coalesce(bonus_revenue,0)
        WHEN (ac_rate) is null or (1) is null or (ac_rate) = 0
        THEN 0.0
        ELSE coalesce(bonus_revenue,0) * (1)/(ac_rate)
        END)) as b_revenue,
    sum(t_impressions) as t_impressions, sum(t_rawclicks) as t_rawclicks,
    sum(t_registrations) as t_registrations, sum ((CASE
        WHEN (pc_rate) = (1)
        THEN (cost)
        WHEN (pc_rate) is null or (1) is null or (pc_rate) = 0
        THEN 0.0
        ELSE (cost) * (1)/(pc_rate)
        END)) as tcost,
    sum ((CASE
        WHEN (ac_rate) = (1)
        THEN (adj_revenue)
        WHEN (ac_rate) is null or (1) is null or (ac_rate) = 0
        THEN 0.0
        ELSE (adj_revenue) * (1)/(ac_rate)
        END) − (CASE
        WHEN (pc_rate) = (1)
        THEN (cost)
        WHEN (pc_rate) is null or (1) is null or (pc_rate) = 0
        THEN 0.0
        ELSE (cost) * (1)/(pc_rate)
        END)) as profit,
    CASE
      WHEN sum(impressions) is not null
      THEN 1
      ELSE 0
    END as impressions_adjusted,
    CASE
      WHEN sum(rawclicks) is not null
      THEN 1
      ELSE 0
    END as rawclicks_adjusted,
    CASE
      WHEN sum(registrations) is not null
      THEN 1
      ELSE 0
    END as registrations_adjusted,
    CASE
      WHEN sum ((CASE
          WHEN (pc_rate) = (1)
          THEN (cost)
          WHEN (pc_rate) is null or (1) is null or (pc_rate) = 0
          THEN 0.0
          ELSE (cost) * (1)/(pc_rate)
        END)) > 0
      THEN sum ( (CASE
          WHEN (ac_rate) = (1)
          THEN (adj_revenue)
          WHEN (ac_rate) is null or (1) is null or (ac_rate) = 0
          THEN 0.0
          ELSE (adj_revenue) * (1)/(ac_rate)
        END) − (CASE
          WHEN (pc_rate) = (1)
          THEN (cost)
          WHEN (pc_rate) is null or (1) is null or (pc_rate) = 0
          THEN 0.0
          ELSE (cost) * (1)/(pc_rate)
        END)) / sum ((CASE
          WHEN (pc_rate) = (1)
          THEN (cost)
          WHEN (pc_rate) is null or (1) is null or (pc_rate) = 0
          THEN 0.0
          ELSE (cost) * (1)/(pc_rate)
        END))
      ELSE null
    END as roi,
    CASE
      WHEN sum(impressions) > 0
      THEN 1000.0*sum ((CASE
          WHEN (ac_rate) = (1)
          THEN (adj_revenue)
          WHEN (ac_rate) is null or (1) is null or (ac_rate) = 0
          THEN 0.0
          ELSE (adj_revenue) * (1)/(ac_rate)
        END)) / (sum(impressions))
      ELSE −1
    END as rpm,
    CASE
      WHEN sum(impressions) > 0
      THEN 1000.0*sum ((CASE
          WHEN (pc_rate) = (1)
          THEN (cost)
          WHEN (pc_rate) is null or (1) is null or (pc_rate) = 0
          THEN 0.0
          ELSE (cost) * (1)/(pc_rate)
        END)) / (sum(impressions))
      ELSE −1
    END as cpm,
    CASE
      WHEN sum(impressions) > 0
      THEN 1000.0*sum ((CASE
          WHEN (ac_rate) = (1)
          THEN (adj_revenue)
          WHEN (ac_rate) is null or (1) is null or (ac_rate) = 0
          THEN 0.0
          ELSE (adj_revenue) * (1)/(ac_rate)
        END) − (CASE
          WHEN (pc_rate) = (1)
          THEN (cost)
          WHEN (pc_rate) is null or (1) is null or (pc_rate) = 0
          THEN 0.0
          ELSE (cost) * (1)/(pc_rate)
        END)) / (sum(impressions))
      ELSE null
    END as gpm,
    CASE
      WHEN sum(impressions) > 0
      THEN 100.0 * sum(rawclicks)/sum(impressions)
      ELSE −1
    END as ctr,
    CASE
      WHEN sum(rawclicks) > 0
      THEN sum ( (CASE
          WHEN (ac_rate) = (1)
          THEN (adj_revenue)
          WHEN (ac_rate) is null or (1) is null or (ac_rate) = 0
          THEN 0.0
          ELSE (adj_revenue) * (1)/(ac_rate)
        END)) /sum(rawclicks)
      ELSE −1
    END as rpc,
    CASE
      WHEN sum(impressions) > 0
      THEN 100.0 * sum(registrations)/sum(impressions)
      ELSE −1
    END as convrate,
    CASE
      WHEN sum(registrations) > 0
      THEN sum ((CASE
          WHEN (ac_rate) = (1)
          THEN (adj_revenue)
          WHEN (ac_rate) is null or (1) is null or (ac_rate) = 0
          THEN 0.0
          ELSE (adj_revenue) * (1)/(ac_rate)
        END))/sum(registrations)
      ELSE −1
    END as rpa,
    CASE
      WHEN sum(t_impressions) > 0
      THEN 1000.0 * sum ( (CASE
          WHEN (ac_rate) = (1)
          THEN (adj_revenue)
          WHEN (ac_rate) is null or (1) is null or (ac_rate) = 0
          THEN 0.0
          ELSE (adj_revenue) * (1)/(ac_rate)
        END)) /sum(t_impressions)
      ELSE −1
    END as ecpm,
    CASE
      WHEN sum(rawclicks) <> 0
      THEN sum(registrations)/sum(rawclicks)
      ELSE −1
    END as apc,
    CASE
      WHEN sum(rawclicks) <> 0
      THEN sum ( (CASE
          WHEN (ac_rate) = (1)
          THEN (adj_revenue)
          WHEN (ac_rate) is null or (1) is null or (ac_rate) = 0
          THEN 0.0
          ELSE (adj_revenue) * (1)/(ac_rate)
        END) − (CASE
          WHEN (pc_rate) = (1)
          THEN (cost)
          WHEN (pc_rate) is null or (1) is null or (pc_rate) = 0
          THEN 0.0
          ELSE (cost) * (1)/(pc_rate)
        END)) /sum(rawclicks)
      ELSE null
    END as gppc,
    CASE
      WHEN sum(registrations) <> 0
      THEN sum ( (CASE
          WHEN (ac_rate) = (1)
          THEN (adj_revenue)
          WHEN (ac_rate) is null or (1) is null or (ac_rate) = 0
          THEN 0.0
          ELSE (adj_revenue) * (1)/(ac_rate)
        END) − (CASE
          WHEN (pc_rate) = (1)
          THEN (cost)
          WHEN (pc_rate) is null or (1) is null or (pc_rate) = 0
          THEN 0.0
          ELSE (cost) * (1)/(pc_rate)
        END))/sum(registrations)
      ELSE null
    END as gppa,
    CASE
      WHEN sum(coalesce((CASE
          WHEN (ac_rate) = (1)
          THEN (adj_revenue)
          WHEN (ac_rate) is null or (1) is null or (ac_rate) = 0
          THEN 0.0
          ELSE (adj_revenue) * (1)/(ac_rate)
        END),0)) <> 0
      THEN (sum(coalesce ( (CASE
          WHEN (ac_rate) = (1)
          THEN (adj_revenue)
          WHEN (ac_rate) is null or (1) is null or (ac_rate) = 0
          THEN 0.0
          ELSE (adj_revenue) * (1)/(ac_rate)
        END),0)) − sum ( (CASE
          WHEN (pc_rate) = (1)
          THEN (cost)
          WHEN (pc_rate) is null or (1) is null or (pc_rate) = 0
          THEN 0.0
          ELSE (cost) * (1)/(pc_rate)
        END))) / sum(coalesce ((CASE
          WHEN (ac_rate) = (1)
          THEN (adj_revenue)
          WHEN (ac_rate) is null or (1) is null or (ac_rate) = 0
          THEN 0.0
            ELSE (adj_revenue) * (1)/(ac_rate)
          END),0))
        ELSE null
      END as mrgn , ‘-’ as adtype_name , −1 as creatives_n, −1 as acamps_n , −1 as
    publishers_n
    FROM
      table (fn_revenue_report2(date(‘2007-08-11’), date(‘2007-08-11’), −1, −1, −1, −1, −1, −1, −1, −
    1)) sr
    JOIN
      locations l
      ON
      sr.node_id = l.location_id
    WHERE
      sr.date BETWEEN ‘2007-08-11’
      and ‘2007-08-11’
      and cr_name != ‘_SDC_NOSERV_’
      and sr.po_test = 0
    GROUP BY
      grouping sets((sr.date, l.location_id, l.name), (l.location_id, l.name),( ))
    ORDER BY
      grouping(name) , location_id, name, sr.date , impressions DESC OPTIMIZE FOR 1000
    ROWS
    WITH
      Ur
```

What is claimed is:

1. A computer-implemented method comprising:
receiving data characterizing a query in accordance with a structured query language format;
determining whether the query includes qualified function calls;
if the query includes the qualified function calls, performing operations comprising:
mapping available values from the qualified function calls to available parameters of qualified functions referred to by the qualified function calls;
replacing the qualified function calls with data derived from a body of code to be executed when a corresponding function is called, the replacing to generate a modified query and the data derived from the body of code based on the mapping; and
providing the modified query to be executed as a substitute for an original version of the query.

2. The method of claim 1, wherein the structured query language is in accordance with the American National Standards Institute Structured Query Language 92 standard.

3. The method of claim 1, wherein the method is performed by a database optimization engine.

4. The method of claim 1, wherein the method is performed by a client.

5. The method of claim 1, wherein the method is performed by a proxy.

6. The method of claim 1 further comprising:
caching versions of the qualified functions calls, wherein replacing is performed using the cached versions of the qualified function calls.

7. The method of claim 1, wherein the qualified function calls are calls to scalar user-defined functions.

8. The method of claim 1, wherein the qualified function calls are calls to scalar user-defined functions absent of variable declarations in their bodies.

9. The method of claim 1 further comprising:
receiving metadata for the qualified functions.

10. The method of claim 1, wherein the replacing comprises copying the body of code to replace the qualified function calls.

11. The method of claim 1, wherein the replacing comprises evaluating statements of the body of code to generate the data derived from the body of code.

12. A computer program product, tangibly embodied on a computer-readable medium, the product comprising instructions to cause a data processing apparatus to perform operations comprising:
receiving data characterizing a query in accordance with a structured query language format;
determining whether the query includes qualified function calls;
if the query includes the qualified function calls, performing operations comprising:
mapping available values from the qualified function calls to available parameters of qualified functions referred to by the qualified function calls;
replacing the qualified function calls with data derived from a body of code to be executed when a corresponding function is called, the replacing to generate a modified query and the data derived from the body of code based on the mapping; and
providing the modified query to be executed as a substitute for an original version of the query.

13. The product of claim 12, wherein the structured query language is in accordance with the American National Standards Institute Structured Query Language 92 standard.

14. The product of claim 12, wherein the operations are performed by a database optimization engine.

15. The product of claim 12, wherein the method is performed by a client.

16. The product of claim 12, wherein the method is performed by a proxy.

17. The product of claim 12 further comprising:
caching versions of the qualified functions calls, wherein replacing is performed using the cached versions of the qualified function calls.

18. The product of claim 12, wherein the qualified function calls are calls to scalar user-defined functions.

19. The product of claim 12, wherein the qualified function calls are calls to scalar user-defined functions absent of variable declarations in their bodies.

20. The product of claim 12 further comprising:
receiving metadata for functions corresponding to the qualified function calls.

21. A system comprising:
at least one processor; and
at least one memory, wherein the at least one processor and the at least one memory are configured to provide a method comprising:
receiving data characterizing a query in accordance with a structured query language format;
determining whether the query includes qualified function calls;
if the query includes the qualified function calls, performing operations comprising:
mapping available values from the qualified function calls to available parameters of qualified functions referred to by the qualified function calls;
replacing the qualified function calls with data derived from a body of code to be executed when a corresponding function is called, the replacing to generate a modified query and the data derived from the body of code based on the mapping; and
providing the modified query to be executed as a substitute for an original version of the query.

22. The system of claim 21, wherein the structured query language is in accordance with the American National Standards Institute Structured Query Language 92 standard.

23. The system of claim 21, wherein the operations are performed by a database optimization engine.

24. The system of claim 21, wherein the method is performed by a client.

25. The system of claim 21, wherein the method is performed by a proxy.

26. The system of claim 21 further comprising:
caching versions of the qualified functions calls, wherein replacing is performed using the cached versions of the qualified function calls.

27. The system of claim 21, wherein the qualified function calls are calls to scalar user-defined functions.

28. A computer-implemented method comprising:
retrieving metadata characterizing user-defined functions;
receiving data characterizing a query in accordance with a Structured Query Language language;
determining whether the query includes function calls for scalar user-defined functions absent of declarations of variables in their bodies, the determining comprising parsing the query in view of the metadata; and
if the query includes function calls for scalar user-defined functions absent of declarations of variables in their bodies, performing operations comprising:
mapping one or more values from the function calls to one or more parameters of one or more of the functions referred to by the function calls;
replacing at least one of the function calls with data derived from a body of code to be executed when a corresponding function is called, the replacing to generate a modified query and the data derived from the body of code based on the mapping; and
providing the modified query to be executed as a substitute for an original version of the query.
